(19) United States
(12) Patent Application Publication
(10) Pub. No.: US 2002/0050383 A1
(43) Pub. Date: May 2, 2002

(54) Switch box cover

(76) Inventor: Patrick C. Westlake, Hammondsville, OH (US)

Correspondence Address: Russell D. Orkin, 700 Koppers Building, 436 Seventh Avenue, Pittsburgh, PA, 15219-1818, US

(21) Appl. No.: 09/881,988

(22) Filed: Jun. 15, 2001

Related U.S. Application Data
(60) Provisional application No. 60/212,480, filed on Jun. 16, 2000.

(51) Int. Cl. H02G 3/08

(52) U.S. Cl. 174/66

(57) ABSTRACT

The present invention is a switch box cover for use in conjunction with a switch box. The switch box cover includes a plate element having a rim portion, an elevated portion, and a transition portion connecting the rim portion with the elevated portion. The plate element has at least one slot on the rim portion, which is configured to accept a fasting mechanism. In operation, the switch box cover is placed over an open side of the switch box, and the switch box cover is secured to the switch box via the fastening mechanism extending through the slot.

### BACKGROUND OF THE INVENTION

1. Field of the Invention

The present invention relates generally to electrical switch box devices, and, in particular, to an extension cover for switch boxes.

2. Description of the Prior Art

In the field of electrical wiring, switch boxes are used to house electrical wires at certain junctions throughout the electrical system. These switch boxes, typically a square, steel box structure, are designed and manufactured to conform with the National Electrical Code, ensuring uniformity throughout the United States. While these switch boxes are normally capable of housing the bunched wires within the confines of the box, in many installation instances, the box is not large enough to comfortably hold the wiring. In these cases, the electrician may force and squeeze the wiring into the box before attaching the front cover plate, increasing the chances of wire damage. In addition, with the recent increase in computer wiring installations, the box cannot securely hold the large bunches of wiring.

In order to alleviate this problem, switch box extensions have been developed. One variation of these extensions is shaped like a square box, however, unlike the switch box, the extension has no back plate. In use, an electrician will attach the extension to the front of the switch box, via screws, essentially doubling the area for the wires. After attaching the extension, the electrician will attach the front plate to the front of the extension, making one, large switch box. While this extended switch box has ample room for wiring, in most cases it has more room than is required. Yet another drawback is the need for both the extension as well as the front cover plate, forcing the electrician to carry both parts to each site. These extensions are costly to manufacture and are not easily “stackable” for storage and distribution.

In another variation of a typical extension, the front cover plate is formed with an elevated central portion, having four screw orifices on the corners of the extended front cover plate. These extensions are also costly to manufacture and are not easily “stackable” for storage and distribution. Additionally, in this variation, the screws must be wholly removed from the structure to allow cover removal and access to the wiring within the switch box.

### SUMMARY OF THE INVENTION

It is therefore an object of the present invention to provide a switch box cover that acts as an integrated extension and front cover plate. It is another object of the present invention to provide a switch box cover that is inexpensive to manufacture and is also easy to stack. It is another object of the present invention to provide a switch box cover that provides ample space for excess wiring, yet allows the switch box to fit in all installation situations. It is a still further object of the present invention to provide a switch box cover that is simple in its installation and maintenance in the field.

Accordingly, I have invented a switch box cover that includes a metallic plate element; the plate element having a rim portion, a transition portion and an elevated portion. Further, on at least one corner of the rim portion is a slot configured to accept a fastening mechanism.

In operation, after the electrician places the wires within the switch box, the switch box cover is placed over the open face of the switch box. As the box has screw orifices on opposite corners of the face of the box, the slot or slots are lined up with the switch box screw orifices. Once aligned, a fastening mechanism or mechanisms, such as screws, are inserted and fastened through the screw orifices and the slots, securing the switch box cover to the switch box. No additional structure is needed, as the elevated portion of the plate element fully covers the open face of the switch box. In addition, in certain of the preferred embodiments, providing slots, as opposed to orifices, on the corner or corners of the switch box cover allows for easy removal. The electrician may simply loosen the screws only enough so that the switch box cover can be slid off of the face of the switch box via the slots. Also, the “cupped” shape of the switch box cover serves to aid in stacking multiple switch box covers, the elevated portion of one switch box cover held immediately adjacent the elevated portion of a second switch box cover.

The present invention, both as to its construction and its method of operation, together with additional objects and advantages thereof, will best be understood from the following description of specific embodiments when read in connection with accompanying drawings.

### BRIEF DESCRIPTION OF THE DRAWINGS

FIG. 1 is a top view of a first embodiment according to the present invention;

FIG. 2 is a side view of the embodiment in FIG. 1;

FIG. 3 is a side sectional view of the embodiment in FIG. 1;

FIG. 4 is a top view of a second embodiment according to the present invention; and

FIG. 5 is a top view of a third embodiment according to the present invention.

### DETAILED DESCRIPTION OF THE PREFERRED EMBODIMENT

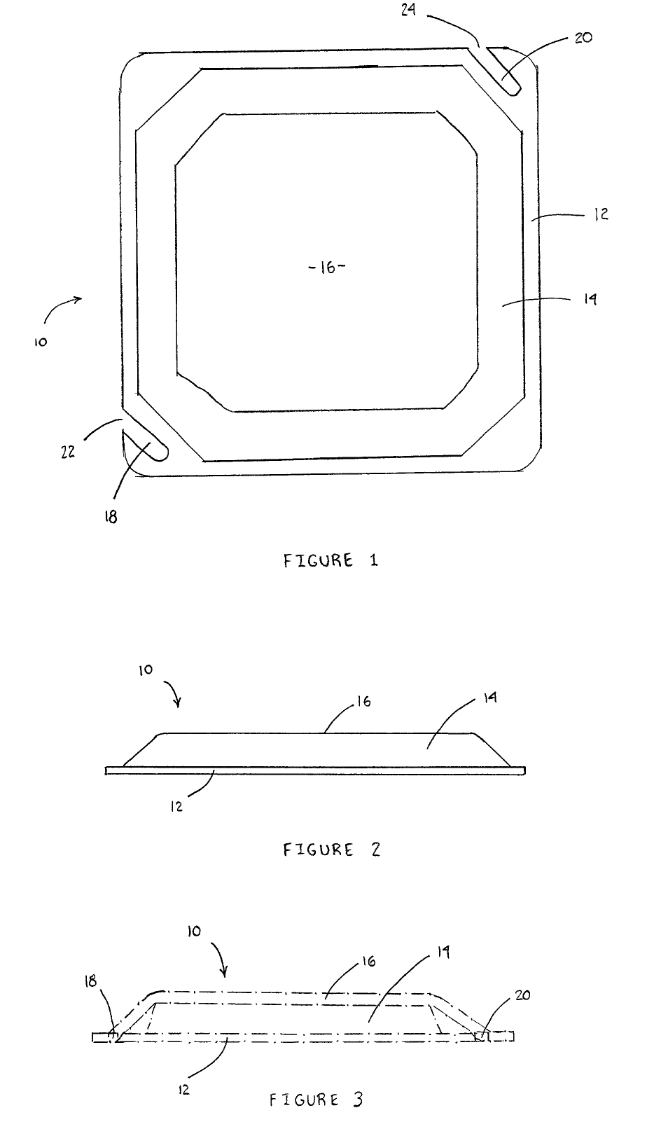

A first embodiment of the switch box cover 10 of the present invention is generally shown in FIGS. 1-3. The present invention switch box cover 10 is formed of metal and includes a plate element 11, having a rim portion 12, a transition portion 14 and an elevated portion 16. In a first embodiment of the present invention, on opposite corners of the plate element 11 are two slots 18 and 20. These slots 18 and 20 are configured to accept a fastening mechanism 19, typically a screw.

As shown in FIGS. 1-4, the switch box cover 10 may have a substantially square-shaped plate element. As a typical switch box has slightly rounded corners, the plate element 11 may likewise have rounded corners. The rim portion 12 of the plate element 11 is flat and runs around the periphery of the plate element 11. Immediately adjacent the rim portion 12 and on an inner periphery of the plate element 11 is a transition portion 14 which slopes upward and inward from the rim portion 12. When viewed from the top, the transition portion 14 is substantially square-shaped with truncated corners. Immediately adjacent the transition portion 14 is an elevated portion 16. When viewed from the top, the elevated portion 16, as with the transition portion 14, is substantially square-shaped with truncated corners. In addition, the elevated portion 16 is a flat, planar area located centrally on the plate element 11. As seen in FIG. 2, when viewed from the side, the switch box cover 10 creates an elevated, metallic structure with a flat rim portion 12, a sloped transition portion 14 and a flat elevated portion 16. As shown in FIG. 5, the switch box cover 10 may also have a substantially octagonal-shaped plate element 11.

In this first embodiment, located on opposite corners of the rim portion 12 of the plate element 11 are two slots 18 and 20. These slots 18 and 20 are configured to accept a fastening mechanism, typically a screw. Slot 18 extends through a first edge 13 and into the rim portion 12 adjacent a first corner 15 of the plate element 11. Further, slot 18 extends in a substantially angular orientation, typically 45°, with respect to the first edge 13 of the plate element 11. Slot 20 extends through a second edge 17 and into the rim portion 12 of the plate element 11. In the first embodiment, slot 20 extends through the second edge 17 and into the rim portion 12 of the plate element 11 in a substantially angular orientation, typically parallel to the angular orientation of slot 18. In addition, the slots 18 and 20 are shaped so as to accept a fastening mechanism 19, such as screws, through the slots 18 and 20, yet still allow for slight variation in alignment of the slots 18 and 20 with switch box screw orifices. Slots 18 and 20 are formed with slot mouths 22 and 24, which allow an electrician to slide the slot mouths 22 and 24 around a screw 19 already partially threaded into the switch box screw orifices.

In installation, an electrician makes a determination whether an extension is required. If so required, the switch box cover 10 is placed over an open face area on a switch box, acting as both an extension and a cover plate. The slots 18 and 20 of the switch box cover 10 are aligned with the switch box screw orifices, and screws 19 are inserted through the slots 18 and 20 and threaded into the switch box screw orifices. The switch box cover 10 is substantially aligned with the switch box, and the screws 19 are tightened, securely fastening the switch box cover 10 to the switch box.

If the electrician must work on a switch box already having a switch box cover 10 attached, he or she only need loosen the screws 19, as opposed to removing the screws 19. Once the screws 19 are loosened, the electrician may laterally move the switch box cover 10 from the switch box via the slots 18 and 20. Once switch box cover 10 is removed, the electrician may work with the internal wiring, and, thereafter, easily slide the switch box cover 10 back onto the switch box using the slot mouths 22 and 24. After the switch box cover 10 is re-aligned with the switch box, the screws 19 are again tightened, securing the switch box cover 10 to the switch box.

It is also envisioned that orifices may be inserted through the corners opposite the currently slotted corners of the plate element 11. Adding either one or two orifices on the alternate corners would allow the electrician to further secure the switch box cover 10 to the switch box via additional screws 19.

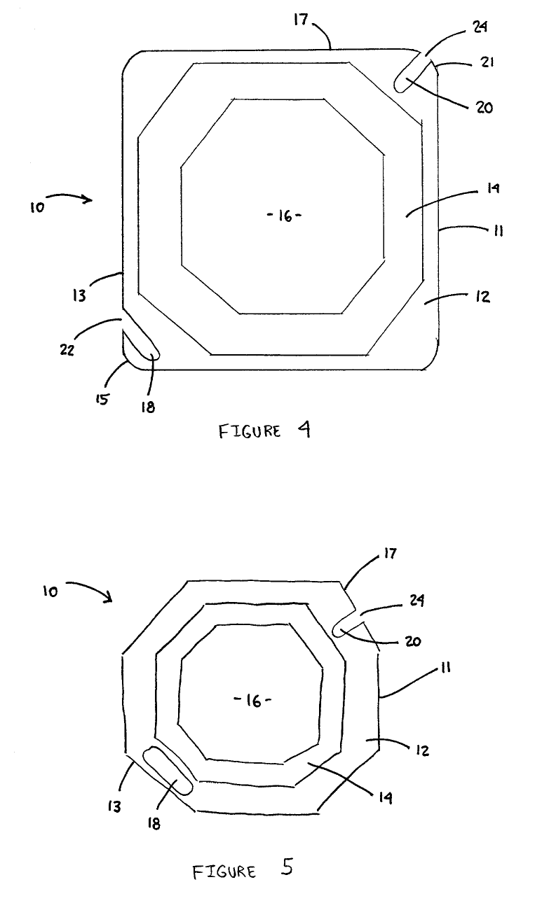

In a second embodiment, shown in FIG. 4, the second slot 20 may extend through a second corner 21 of the plate element 11. In this embodiment, the slot 20 extends at an angle transverse to the angular orientation of the first slot 18.

In a third embodiment, shown in FIG. 5, the plate element 11 has a substantially octagonal shape. In this embodiment, the slot 18 extends through the rim portion 12 of the plate element 11 adjacent the first edge 13 of the plate element 11. Slot 18 extends at an angle parallel with the first edge 13. In this third embodiment, slot 20 extends through the second edge 17 and into the rim portion 12 of the plate element 11 at an angle transverse to the angular orientation of slot 18. As the plate element 11 has a substantially octagonal shape, all of the rim portion 12, the transition portion 14 and the elevated portion 16 also have a substantially octagonal shape. However, all three discussed embodiments are similar in that the elevated portion 16 lies on a different plane than the rim portion 12.

In its manufacture, the switch box cover 10 is typically formed from galvanized carbon steel or similar mild steel. In using plain galvanized steel, the switch box cover 10 is much cheaper in its manufacture than other available extensions, which require drawing quality galvanized steel. These more expensive steels are required in manufacturing other extensions due to the complicated structure formed in the stamping process. Further, the complicated structure of the other extensions results in high tooling costs and low production speed. Conversely, due to the shape of the present invention, the switch box cover 10 has low tooling costs, low steel costs and is able to be manufactured at a much higher rate than other extensions.

In addition, the switch box cover 10 of the present invention is easily stackable. As seen in FIGS. 1-5, the shape of the switch box cover 10 allows the transition portion 14/raised portion 16 area of one switch box cover 10 to be placed immediately adjacent to the transition portion 14/raised portion 16 of a second switch box cover 10. In this manner, an unlimited amount of switch box covers 10 may be stacked and easily transported with the electrician to and from the field. Also, as some prior art extensions require additional face cover plates, multiple pieces are required to be with the electrician for use. The switch box cover 10 of the present invention serves to both extend and cover the switch box. This adds to the convenience of the electrician, while decreasing installation time.

This invention has been described with reference to the preferred embodiments. Obvious modifications and alterations will occur to others upon reading and understanding the preceding detailed description. It is intended that the invention be construed as including all such modifications and alterations.

I claim:

1. A switch box cover, comprising:
a plate element having a rim portion, an elevated portion, and a transition portion connecting the rim portion with the elevated portion; and
at least one slot on the rim portion of the plate element and configured to accept a fastening mechanism;
wherein, in operation, the switch box cover is placed over an open side of a switch box, and the switch box cover is secured to the switch box via the fastening mechanism extending through the at least one slot.

2. The switch box cover of claim 1, wherein the plate element has a substantially square shape, and the at least one slot extends through a first edge and into the rim portion adjacent a first corner of the plate element at a substantially angular orientation, with respect to the first edge of the plate element.

3. The switch box cover of claim 2, wherein the angular orientation is 45°.

4. The switch box cover of claim 1, further comprising a second slot extending through a second edge and into the rim portion of the plate element and configured to accept a second fastening mechanism.

5. The switch box cover of claim 4, wherein the plate element has a substantially square shape, the at least one slot extends through a first edge and into the rim portion adjacent a first corner of the plate element at a substantially angular orientation, with respect to the first edge of the plate element, and the second slot extends through a second edge and into the rim portion of the plate element.

6. The switch box cover of claim 5, wherein the second slot extends through the second edge and into the rim portion adjacent a second corner of the plate element at a substantially angular orientation, with respect to the second edge of the plate element.

7. The switch box cover of claim 6, wherein the angular orientation of the second slot is parallel to the angular orientation of the first slot.

8. The switch box cover of claim 5, wherein the second slot extends through a second corner of the plate element at an angle transverse to the angular orientation of the first slot.

9. The switch box cover of claim 1, wherein the plate element has a substantially octagonal shape.

10. The switch box cover of claim 9, wherein the at least one slot extends through the rim portion of the plate element adjacent a first edge of the plate element.

11. The switch box cover of claim 10, wherein the at least one slot extends at an angle parallel to the angle of the first edge of the plate element.

12. The switch box cover of claim 9, further comprising a second slot extending through a second edge and into the rim portion of the plate element and configured to accept a second fastening mechanism.

13. The switch box cover of claim 12, wherein the second slot extends through a second corner of the plate element at an angle transverse to the angular orientation of the first slot.

14. The switch box cover of claim 1, wherein the elevated portion of the plate element lies on a different plane than the rim portion of the plate element.

15. The switch box cover of claim 1, wherein the fastening mechanism is a screw.

16. The switch box cover of claim 1, wherein the plate element is formed of a galvanized carbon steel.

17. A switch box cover, comprising:
a substantially square-shaped plate element having a rim portion, an elevated portion, and a transition portion connecting the rim portion with the elevated portion;
a first slot on the rim portion of the plate element and configured to accept a first fastening mechanism;
a second slot extending through an edge and into the rim portion of the plate element and configured to accept a second fastening mechanism;
wherein the elevated portion of the plate element lies on a different plane than the rim portion of the plate element; and
wherein, in operation, the switch box cover is placed over an open side of a switch box, and the switch box cover is secured to the switch box via the first fastening mechanism extending through the first slot and via the second fastening mechanism extending through the second slot.

18. A switch box cover, comprising:
a substantially octagonal-shaped plate element having a rim portion, an elevated portion, and a transition portion connecting the rim portion with the elevated portion;
a first slot extending through the rim portion of the plate element adjacent a first edge of the plate element and configured to accept a first fastening mechanism;
a second slot extending through a second edge and into the rim portion of the plate element and configured to accept a second fastening mechanism;
wherein the elevated portion of the plate element lies on a different plane than the rim portion of the plate element; and
wherein, in operation, the switch box cover is placed over an open side of a switch box, and the switch box cover is secured to the switch box via the first fastening mechanism extending through the first slot and via the second fastening mechanism extending through the second slot.
